(19) United States
(12) Patent Application Publication
(10) Pub. No.: US 2015/0128185 A1
(43) Pub. Date: May 7, 2015

(54) SYSTEM AND METHOD FOR PERSONALIZATION OF AN APPLICANCE BY USING CONTEXT INFORMATION

(71) Applicant: Tata Consultancy Services Limited, Mumbai, Maharashtra (IN)

(72) Inventors: Kingshuk Chakravarty, Kolkata (IN); Debatri Chatterjee, Kolkata (IN); Somnath Ghosh Dastidar, Kolkata (IN); Aniruddha Sinha, Kolkata (IN)

(21) Appl. No.: 14/399,442

(22) PCT Filed: May 16, 2013
(86) PCT No.: PCT/IN13/00317

§ 371 Date: Nov. 6, 2014

(30) Foreign Application Priority Data
May 16, 2012 (IN) 1488/MUM/2012

(51) Int. Cl. H04N 21/482; H04N 21/485; H04N 21/45

(52) U.S. Cl. CPC H04N 21/482; H04N 21/4532; H04N 21/4852; H04N 21/4854; H04N 21/4856; H04N 21/4858
USPC 725/46

(57) ABSTRACT

Disclosed is a system and method for personalizing an appliance's functioning remotely in real-time. The user profile and set of parameters affecting the functionality of the appliance are received by a computing device by, for example, communication module and are matched by a data delivery device to pre-defined parameters stored therein, for the profile categorization. An output profile is generated and is defined by matched parameters. The appliance is remotely controlled by modifying the functioning of the appliance in accordance with the output profile defined by the matched parameters.

### FIELD OF THE INVENTION

This present application generally relates to personalization of television applications. Particularly, the present invention relates to automatic adaptation and personalization of television user interface using user context information extracted from second screen devices in real-time.

### BACKGROUND OF THE INVENTION

Education to all is considered right in most countries of the world. India alone has around 210 million students studying in 1.4 million schools that provide employment to 7 million people making the education system of India one of the largest in the world. However, dearth of skilled teachers remains a major hindrance to the spread of education, especially in remote areas of rural India and many other countries.

A lot of focus has been given to improve the education system around the world for example; free online content is made available on internet. Video-conferencing platforms like Skype and other internet based messengers are also utilized for imparting education in the remote areas. However, such means are rarely utilized by a broader cross-section of population due to the lack of the required infrastructure or expertise. With the expansion of smart TV, more and more education related applications are emerging that are specific for the Television that is ubiquitous in developing countries as well. Distance education as means for education has been there for long time but it is gaining popularity with the acceptance of smart TV. The tutorials for the distance education consist of video lectures and associated question-answers (QA). A single lecture content (video, audio and QA) for a given subject and standard is prepared for all the target audience. However, distance education is opted by a variety of users ranging from college students, adults, housewives and elderly people. The same subject may be opted by elderly people and school students. However, there are differences in visual contrast sensitivity, capability of handling cognitive load and preferences. Based on this information, the content is never adapted in the TV applications which are meant for personal use.

The present state of art does mention about the availability of distinct user context information related to UI on devices such as mobile phones. However, such information is different for different categories of users and none of the present arts utilize the information regarding the UI of the mobile phone to update the TV application in ubiquitous manner. Such problems related to the UI pose a limitation to the outreach of distance education, however, no attempts have yet been made to customize the television screen automatically based on the profile information stored in a second screen device such as mobile phones that may enable users, specifically people with poor eyesight or visual disorders to utilize distance education related content on television.

In view of the problems stated above there remains a need for optimizing the user interface of the distance education means such as television in accordance with the user interface of a mobile device such as a mobile phone that keeps close track of user preferences. User preferences may differ based on languages, customs, physical deficiencies and experience level. Such differences usually get reflected in the user profiles set in the mobile phone of a person.

Other features and advantages of the present invention will be explained by means of embodiments in the following description of the application having reference to the appended drawings.

### SUMMARY OF THE INVENTION

The present invention provides a system for personalizing an appliance's functioning remotely in real-time. The system comprises of a data delivery device configured to act as an interface between the appliance and the computing device by sensing from the computing device, a user's profile along with a set of parameters affecting the functioning of the appliance by means of a communication module, the set of parameters further representing a category of the user. The data delivery device further comprises of a matching module configured to match the set of parameters associated with the user's profile with a set of pre-defined parameters stored in the data delivery device and categorize the user's profile with respect to a set of stored profiles to generate an output profile, such that each output profile is defined with a matched set of parameters. The data delivery device further comprises of a control module communicating with the data delivery device to modify the appliance's functioning with respect to the matched parameters defined for the output profile.

The present invention also provides a method for connecting an appliance and a computing device. The computing device is capable of personalizing the appliance's functioning remotely. The method comprises of establishing an interaction between the appliance and the computing device by sensing a user's profile along with a set of parameters affecting the functioning of the appliance, the set of parameters further representing a category of a user. The method further comprises of matching the set of parameters associated with the user's profile with a set of pre-defined parameters stored in the data delivery device and categorize the user's profile with respect to a set of stored profiles to generate an output profile, such that each output profile is defined with a matched set of parameters and modifying the appliance's functioning with respect to the matched parameters defined for the output profile.

### BRIEF DESCRIPTION OF DRAWINGS

FIG. 1 illustrates the system architecture in accordance with an embodiment of the invention.

FIG. 2 represents a block diagram of a system (100) for automatic adaptation and personalization of Television, in accordance with an embodiment of the present invention.

FIG. 3 according to an exemplary embodiment illustrates a flowchart of a method (300) for auto adaptation of Television screen.

FIG. 4 according to an exemplary embodiment illustrates a flowchart of a method (400) for selecting a preferred language to be adapted in the television.

### DETAILED DESCRIPTION

Some embodiments of this invention, illustrating its features, will now be discussed:

The words “comprising”, “having”, “containing”, and “including”, and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a”, “an”, and “the” include plural references unless the context clearly dictates otherwise. Although any systems, methods, apparatuses, and devices similar or equivalent to those described herein can be used in the practice or testing of embodiments of the present invention, the preferred, systems and parts are now described. In the following description for the purpose of explanation and understanding reference has been made to numerous embodiments for which the intent is not to limit the scope of the invention.

One or more components of the invention are described as module for the understanding of the specification. For example, a module may include self-contained component in a hardware circuit comprising of logical gate, semiconductor device, integrated circuits or any other discrete component. The module may also be a part of any software program executed by any hardware entity for example processor. The implementation of module as a software program may include a set of logical instructions to be executed by the processor or any other hardware entity. Further a module may be incorporated with the set of instructions or a program by means of an interface.

The disclosed embodiments are merely exemplary of the invention, which may be embodied in various forms.

The present invention provides a system and method for connecting an appliance and a computing device. The interaction provides a capability to the computing device to personalize functioning of the appliance with respect to a category of user. The system provides a sensing of a user's profile along with a set of parameters affecting the functioning of the appliance. The user's profile and the set of parameters are then matched with a pre-stored set of profile and set of parameters. The matching results in an output profile. The output profile is defined with a set of matched parameters. The functioning of the appliance is modified with respect to the matched parameters defined for the output profile in real-time.

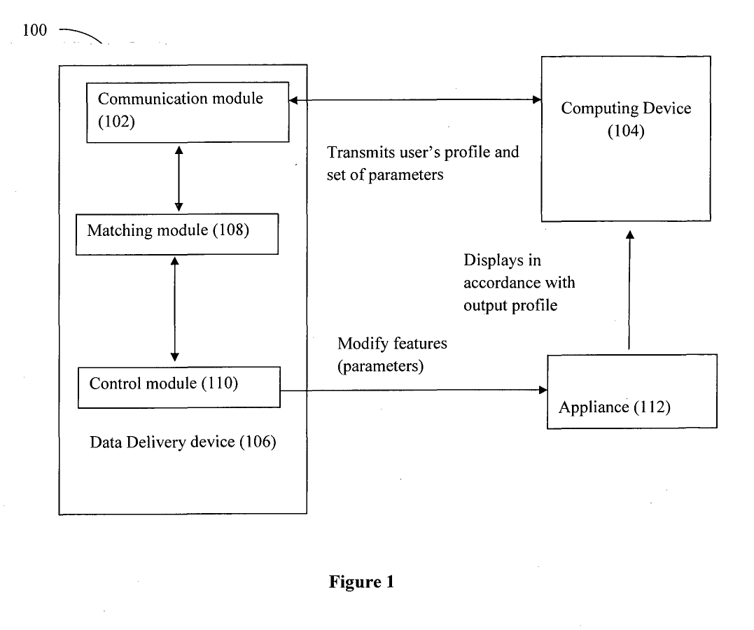

In accordance with an embodiment, referring to FIG. 1, the system (100) comprises of a data delivery device (106) configured to process the user's profile and provided with a communication module (102) to establish a connection between the appliance and (112) the computing device (104),. The data delivery device (106) further comprises of a matching module (108) configured to map the user's profile and associated set of parameters with pre-defined parameters so stored to categorize the user's profile and generate an output profile and a control module (110) configured to modify the functioning of the appliance (112) in accordance with the output profile and the matched parameters.

The communication module (102) establishes a connection between the appliance (112) and the computing device (104). The communication module (102) may include a blue tooth dongle, an internet device, an NFC device and alike and may be present in both the data delivery device (106) and the computing device (104). The appliance (112) may include a television set.

The computing device (104) stores a user's profile along with a set of parameters reflecting the user's cognitive ability and perception level. The set of parameters are used to change the appliance's functionality. The user profile and set of parameters are transmitted to the appliance (112) by the communication module (102). The user profile and the set of parameters may be gathered through different sources and in different ways. Some of the parameters are set by the users themselves, learning human-computing device interactions, user information extracted from the internet cloud etc. The set of parameters represents a category of the user.

The computing device (104) is a device selected from a group of mobile phones, Smartphone, PDA, tablet, and the like. The computing device (104) is generally a dedicated device for a single user that is set according to the needs of that particular user. The computing device (104) may be used to sense user profile information.

The data delivery device (106) is a device that acts as an interface between the computing device and the appliance (112) (TV). The communication module (102) (Bluetooth) supplies the user profile along with the set of parameters. This user profile and the set of parameters are sensed by the data delivery device (106). The data delivery device (106) then processes the user profile and the set of parameters to generate one or more categories of the user. The data delivery device (106) may be adapted to match the user profile and the set of parameters received from the computing device with the stored set of parameters for various users and thereupon creating one or more output profile.

For example, based on the various parameters received from the computing device (104), user categories may be created that may represent a set of users having similar cognitive ability and perception. Such a user category may prompt creation of a profile to which the corresponding profile and set of parameters from the computing device are matched that may be suitable for the appliance (112) (television). Moreover, whenever there is any change in the profile stored in the computing device (104) a corresponding change may also get reflected in the appliance (112) (Television screen) instantaneously. The data delivery device (106) further includes an Over the Top (OTT) box.

The data delivery device (106) further comprises of the matching module (108) to match the user profile and the set of parameters with a pre-defined set of parameters stored in the data delivery device (106). The matching module (108) forms a feature vector set of the set of parameters for different categories so received from different users. These feature vectors are then matched with the pre-defined set of parameters and then decides a user category. Once the category is decided, it generates an output profile. The output profile is defined with a matched set of parameters. The stored profile further includes an elder profile, a house wife profile or a children profile.

The data delivery device (106) further comprises of the control module (110) configured to modify the appliance's (112) functioning with respect to the matched parameters defined for the output profile.

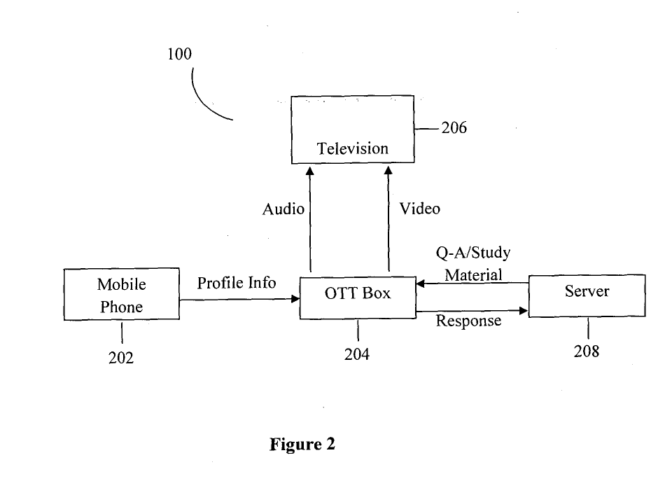

In accordance with an embodiment, FIG. 2 represents a block diagram of a system (100) for automatic adaptation and personalization of Television. The system (100) comprises of a mobile phone (202) that acts as a computing device (104). The mobile phone (202) may be replaced by any other suitable computing as well. The system (100) also comprises of an Over the Top box as referred to as OTT box (204) acting as a data delivery device (106), a Television (206) acting as an appliance (112), and a server (208). For explanatory reasons the interactive and auto-adaptive system (100) is adapted to display education content such as question-answer and study material, however, various type of contents may also be supported by said system.

The mobile phones (202) are generally used as first class personal computing devices by a plurality of people having different cognitive ability and perception. Therefore, mobile phones (202) may be utilized for sensing user cognitive ability and perception. In an aspect, the user profile along with the set of parameters may fall under profile information vectors such as icon size, font Size, foreground color, background color, brightness & contrast, microphone & speaker volume, and the like.

In a related aspect, the mobile phone (202) may be an Android based mobile phone adapted to sense user profile information. In other aspects, the mobile phone (202) may be based on any other Operating System as well. Further, the server (208) may be a remote standalone server that is adapted to store all educational content such as lecture video, image, text, questionnaire files, and the like. The OTT box (204) is adapted to interact with the server (208) by means of a connectivity channel such as internet. The OTT box (104) is also adapted to render the educational content such as question answers on Television (206) screen blended with a lecture video. Furthermore, the OTT box (204) may have an in-built Bluetooth connectivity unit or an external port for connecting with a Bluetooth dongle acting as a communication module (102). The Bluetooth connectivity allows the OTT box to be paired and connected with the mobile phone (202) that may enable sending and receiving files from and to the mobile phone (202).

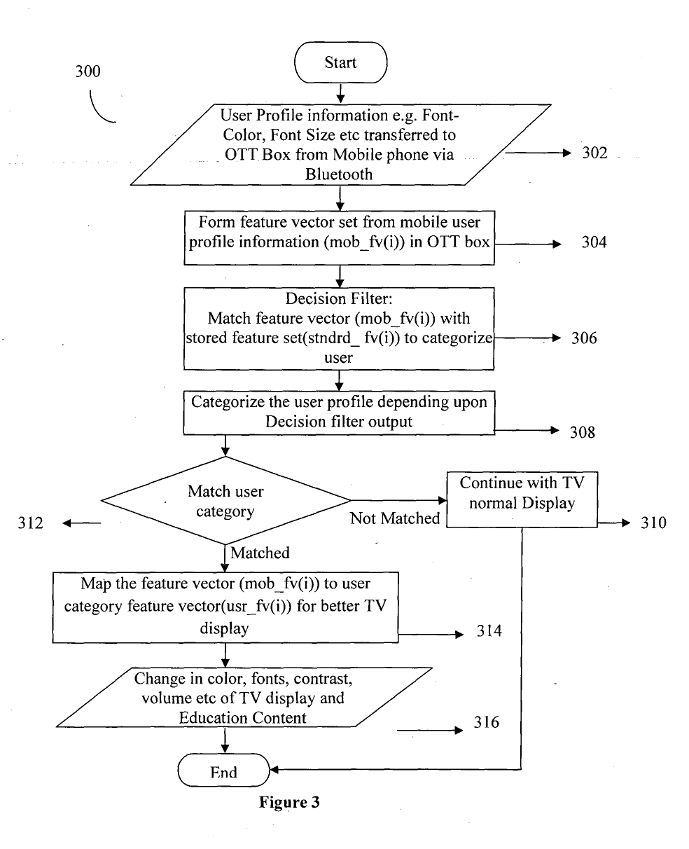

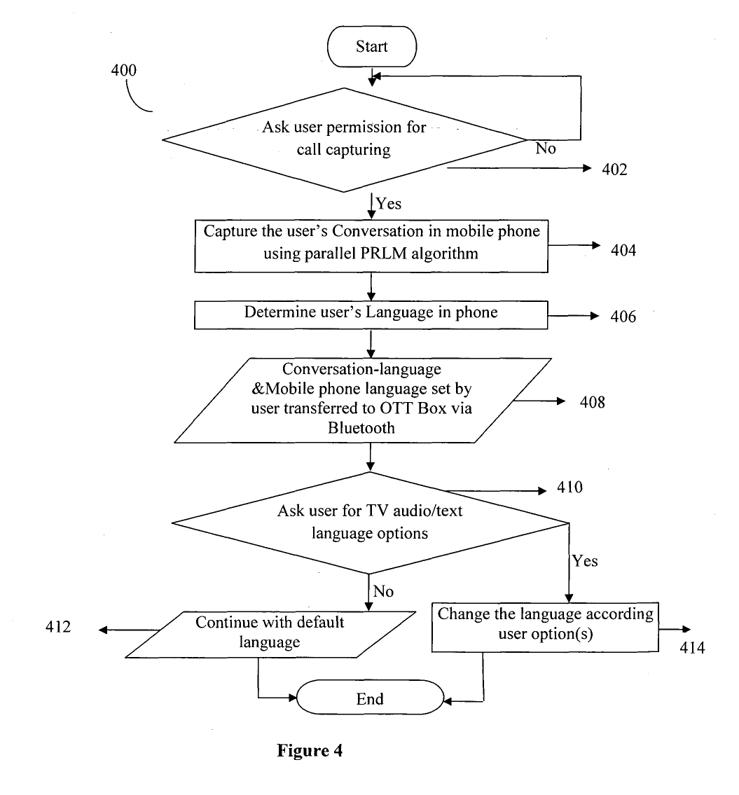

With reference now to FIGS. 3 and 4, represent flowcharts exemplary illustrating exemplary interaction and auto adaptation of the Television in accordance with a computing device (104). It should be appreciated that the figures are only exemplary and are not intended to assert or imply any limitation with regard to the environments in which different embodiments may be implemented. Many modifications to the depicted environments may be made.

The method starts when the Television (206) is switched on to attend a lecture video session on some specific topic. The OTT box (204) connects to the remote server (208) for lecture video or study material, questionnaire and metadata file. Metadata file has the necessary information about questionnaire session. The OTT box (204) blends the question-answer on top of the lecture video frame in a Q-A session.

A user profile sensing application (MOBUSR_PROF_APP) is designed on platform such as Android platform so that it may run on. Android based mobile phone and correctly get the user profile information. The profile sensing application first checks whether the profile information vector (user profile along with the set of parameters) is set on mobile-phone or not. If it is not set it will prompt user to set the profile manually. Otherwise it will send this profile information vector to OTT box (step 302). Then OTT box (204) may extract feature vector set (mob_fv(i)) which may then be used to categorize user profile. After getting feature vector set, OTT display application (OTT_App_Disp) will match the feature vector set(mob_fv(i)) with its stored standard feature vector set(stndrd_fv(i)) by means of the matching module (108)to categorize the user (step 304). Under this application, (OTT_App_Disp) distinguishing parameters and their standard levels for different target users (i.e Elderly, housewives etc) are selected based on the literature survey and guidelines available for system (100) design. These distinguishing parameters are used to form the standard feature vector (stndrd_fv(i)) for that particular target user and are stored in the OTT box. This feature vector is used for category matching in OTT_App_Disp.

The user profile information (set of parameters) obtained from mobile phone are used to form a similar feture vector((mob_fv(i)). Then a comparison is done between mob_fv(i)) and stndrd_fv(i), by using Eucledian distance measure. The comparison can also be done using other standard distance measure approach.

This matching (maping) of mob_fv(i) with respect to stndrd_fv(i) is done in Decision Filter section of the application OTT_App_Disp (step 306). If the output of the Decision Filter is “Elderly”, OTT_App_Disp will map the mob_fv(i) with elderly feature vector set (eldr_fv(i)) and generates an output profile as the elder profile defined with a matched parameters (features) (step 308 and 312).

If the set of parameters (vector features) does not matches with the parameters stored in the data delivery device (106), the system continues with normal TV display (step 310).

The control module (110) then modifies the functionality (features) of the TV in accordance with the output profile and the matched parameters (features). The set of parameters like color, contrast, fonts, volume etcof TV display and education content will be changed. As an output, user can observe changes in TV display for education content (step 314 and 316).

Referring to FIG. 4, the computing device (106) further comprises of a capturing module (not shown in figure) configured to capture a language of communication of the user by obtaining user's consent (step 402). If the user does not provide the consent, the system displays the content in normal language (as set) without capturing. The data computing device (106) by way of MOBUSR_PROF_APP (OTT_App_Disp) application also captures the user conversations with user permission and run Parallel Phone Recognition followed by Language Modeling (parallel PRLM) algorithm on the captured speech to identify the language (step 404 and 406). Then this language information along with mobile phone default languages (set by the user) is transferred to OTT box via Bluetooth (step 408).

OTT box then checks whether the lecture video content has this audio language option. If it has the option, then OTT box by means of the output module will ask for user permission to change the text and audio language for lecture content and questionnaire receptively. The output module provides an option of changing the language of the content displayed by the appliance in accordance with the language of the user or his mobile device (step 410). If the user does not want to change the language, the system continues with default language (step 412). If user provides his permission to change the language, the control module (110) changes the language (step 414). Additionally, the video content can be enhanced based on the contrast settings of the phone.

### ADVANTAGES

Automatic control of appliance thereby reducing manual effort.

Simple devices like mobile used to control appliance.

Sharing of data with simple communication protocol without involving any complicated hardware entity.

1. A system for personalizing an appliance's functioning remotely and in real-time, the system comprising:
a data delivery device configured to act as an interface between the appliance and a computing device by sensing from the computing device, a user's profile along with a set of parameters affecting the functioning of the appliance by communication module, the set of parameters further representing a category of the user, and wherein the data delivery device comprises:
a matching module configured to match the set of parameters associated with the user's profile with a set of pre-defined parameters stored in the data delivery device and categorize the user's profile with respect to a set of stored profiles to generate an output profile, such that each output profile is defined with a matched set of parameters; and
a control module communicating with the data delivery device to modify the appliance's functioning with respect to the matched parameters defined for the output profile.

2. The system of claim 1, wherein the appliance comprises a television set.

3. The system of claim 1, wherein the computing device is selected from a group consisting of a mobile, a landline, a laptop, a and a desktop.

4. The system of claim 1, wherein the data delivery device further comprises of an Over the Top (OTT) box.

5. The system of claim 1, wherein the communication module further comprises blue tooth device, an internet device, or an NFC device.

6. The system of claim 1, wherein the set of parameters associated with the user's profile further comprises icon size, font size, foreground color, background color, brightness and contrast, and microphone and speaker volume.

7. The system of claim 1, wherein the set of stored profiles further comprises an elder profile, a housewife profile, and a children profile.

8. The system of claim 1, wherein the computing device further comprises a capturing module configured to capture a language of communication of the user after obtaining a user's content.

9. The system of claim 1, wherein the control device is further configured to provide an option of changing the language of content displayed by the appliance to the user in accordance with the language of communication so captured.

10. A method for connecting an appliance and a computing device, the computing device capable of personalizing the appliance's functioning remotely, the method comprising:
establishing an interaction between the appliance and the computing device by sensing a user's profile along with a set of parameters affecting the functioning of the appliance, the set of parameters further representing a category of a user;
matching the set of parameters associated with the user's profile with a set of pre-defined parameters stored in the data delivery device and categorizing the user's profile with respect to a set of stored profiles to generate an output profile, such that each output profile is defined with a matched set of parameters; and
modifying the appliance's functioning with respect to the matched parameters defined for the output profile.

11. The method of claim 10, wherein the set of parameters associated with the user's profile further comprises icon size, font size, foreground color, background color, brightness and contrast, and microphone and speaker volume.

12. The method of claim 10 further comprising capturing a language of communication of the user after obtaining a user's content.

13. The method of claim 10, wherein language of communication of the user is captured after obtaining the user's consent to modify the appliance's functioning and to provide an option of changing the language of content displayed by the appliance to the user in accordance with the language of communication so captured.
